(19) United States
(12) Patent Application Publication
(10) Pub. No.: US 2003/0094827 A1
(43) Pub. Date: May 22, 2003

(54) Rooftop deck system for recreational vehicles and the like

(75) Inventors: Thomas G. Faludy, Westminster, CO (US); Jeff Samson, Boulder, CO (US); Brent Christopher, Denver, CO (US); Matthew Rauwerdink, Westminster, CO (US); Scott P. Thompson, Longmont, CO (US)

Correspondence Address: DORSEY & WHITNEY, LLP, INTELLECTUAL PROPERTY DEPARTMENT, 370 SEVENTEENTH STREET, SUITE 4700, DENVER, CO, 80202-5647, US

(73) Assignee: Carefree/Scott Fetzer Company, Broomfield, CO (US)

(21) Appl. No.: 10/300,120

(22) Filed: Nov. 19, 2002

Related U.S. Application Data
(60) Provisional application No. 60/332,591, filed on Nov. 21, 2001.

(51) Int. Cl. B60P 3/34

(52) U.S. Cl. 296/26.06

(57) ABSTRACT

A deck system for the top of a recreational vehicle or the like includes a platform supported by a base framework that is removably attached to the top of the vehicle. Side and end rails along the periphery of the platform are foldable into adjacent overlying relationship with the platform. A retractable awning is further provided for selectively overlying the platform and a collapsible ladder extends to the platform providing easy access.

### CROSS REFERENCE TO RELATED APPLICATIONS

This application claims priority to provisional patent application U.S. 60/332,591 filed Nov. 21, 2001 and the disclosure thereof is hereby incorporated by reference.

### BACKGROUND OF THE INVENTION

1. Field of the Invention

The present invention relates generally to deck systems and more particularly to a deck system for mounting on the roof of a recreational vehicle, motor home or the like.

### BACKGROUND OF THE INVENTION

The use of recreational vehicles is a popular means of vacation travel. Over time, both the size and variety of amenities included in or on recreational vehicles have increased. Many recreational vehicles, by way of example, include a flat roof surface on which racks for carrying accessory items, air conditioning units, or the like have been positioned.

In many instances, recreational vehicles are used to attend sporting events, view natural and historical landmarks, and stay in places of scenic beauty. Often, however, the view from the ground adjacent to the vehicle or from inside the recreational vehicle is not adequate to satisfactorily see the sporting event, the natural or historic landmark, or the surrounding scenic beauty. Accordingly, it would be desirable to have an elevated location such as on the roof of a recreational vehicle from which such activities and views can be obtained.

A rooftop deck system for a motor home is disclosed in U.S. Pat. No. 6,237,988 issued to Messano, which illustrates the need and ability to use the rooftop of a motor home or recreational vehicle as a platform for viewing various sites. The system disclosed in the Messano patent is not entirely satisfactory, however, as it elevates the height of the vehicle significantly even when not in use. Further, there is no system for shading the area on the rooftop from sun, rain, or the like, which limits the use of the system.

It would, therefore, be desirable that a rooftop deck system be employed that is simple in operation, is collapsible into a compact unit on the top of the vehicle without adding significant height to the vehicle and at least optionally, a system for shading and protecting the deck system from environmental elements.

It is to satisfy the above criteria that the present invention has been developed.

### BRIEF SUMMARY OF THE INVENTION

In accordance with the present invention, a rooftop deck system is removably mounted on the roof of a recreational vehicle, motor home, mobile home, or the like and is further movable between expanded and retracted conditions. In a retracted condition, the deck system is folded neatly in closely adjacent relationship with the rooftop of the vehicle while in the expanded condition, side rails and end rails project upwardly from the side and end edges of a base platform.

Further, a retractable awning is mounted to the base platform and is movable between a retracted position folded closely adjacent to the rooftop of the vehicle and an extended position overlying the base platform to provide protection from environmental elements such as sun, rain or the like.

Access to the base platform is provided by an extendable ladder that is mountable either to the platform or a wall of the vehicle with it, too, being movable between a retracted storage position in closely adjacent relationship with a side of the vehicle and an extended use position which is inclined relative to the side of the vehicle. The extendable ladder renders it easy for a user to access the base platform on the top of the vehicle.

The foregoing and other features, utilities, and advantages of the invention will be apparent from the following more particular description of a preferred embodiment of the invention as illustrated in the accompanying drawings.

### BRIEF DESCRIPTION OF THE DRAWINGS

FIG. 1 is an isometric view of a recreational vehicle having the rooftop deck system of the present invention mounted thereon with the awning fully extended.

FIG. 2 is an isometric view similar to FIG. 1 with the awning fully retracted.

FIG. 3 is an isometric similar to FIGS. 1 and 2 with the deck fully collapsed and the ladder folded against the side of the vehicle.

FIG. 4 is an isometric view of the deck without the awning and with side and end railings extended relative to the base platform of the deck.

FIG. 4a is an isometric view similar to FIG. 4 wherein the end rails of the deck have been folded into overlapping relationship with the side rails.

FIG. 4b is an isometric view similar to FIGS. 4 and 4a with the side rails and end rails having been folded downwardly into overlying relationship with the base platform of the deck.

FIG. 5 is a fragmentary vertical transverse section taken through the deck system illustrating the connection between the top of the recreational vehicle and the deck system.

FIG. 6 is a section taken along line 6-6 of FIG. 5.

FIG. 7 is a section taken along line 7-7 of FIG. 4.

FIG. 8 is a section taken along line 8-8 of FIG. 7.

FIG. 9 is a section taken along line 9-9 of FIG. 4.

FIG. 10 is a section taken along line 10-10 of FIG. 9.

FIG. 11 is a section taken along line 11-11 of FIG. 4.

FIG. 12 is a section similar to FIG. 11 with an end rail pivoted into adjacent parallel relationship with a side rail.

FIG. 13 is an isometric view of the base framework of the deck system.

FIG. 14 is a vertical section through the clamp used to hold the deck system in the folded position but wherein the deck system is extended.

FIG. 14a is a section similar to FIG. 14 with the clamp retaining the deck system in the folded position.

FIG. 15 is an isometric view of the retractable awning of the deck system in a fully extended position.

FIG. 16 is an isometric view similar to FIG. 15 with the awning canopy having been removed.

FIG. 17 is a side elevation showing the awning partially folded toward its collapsed position.

FIG. 18 is a side elevation similar to FIG. 17 with the awning further folded toward its fully collapsed position.

FIG. 19 is a side elevation similar to FIGS. 17 and 18 with the awning fully collapsed.

FIG. 20 is an isometric view of the collapsible ladder of the deck system in a fully extended position.

FIG. 21 is an isometric view of the ladder of FIG. 20 in a fully retracted position.

FIG. 22 is a fragmentary section taken along line 22-22 of FIG. 21.

FIG. 23 is a fragmentary section taken along line 23-23 of FIG. 22.

FIG. 24 is a fragmentary section taken along line 24-24 of FIG. 21.

### DETAILED DESCRIPTION OF THE INVENTION

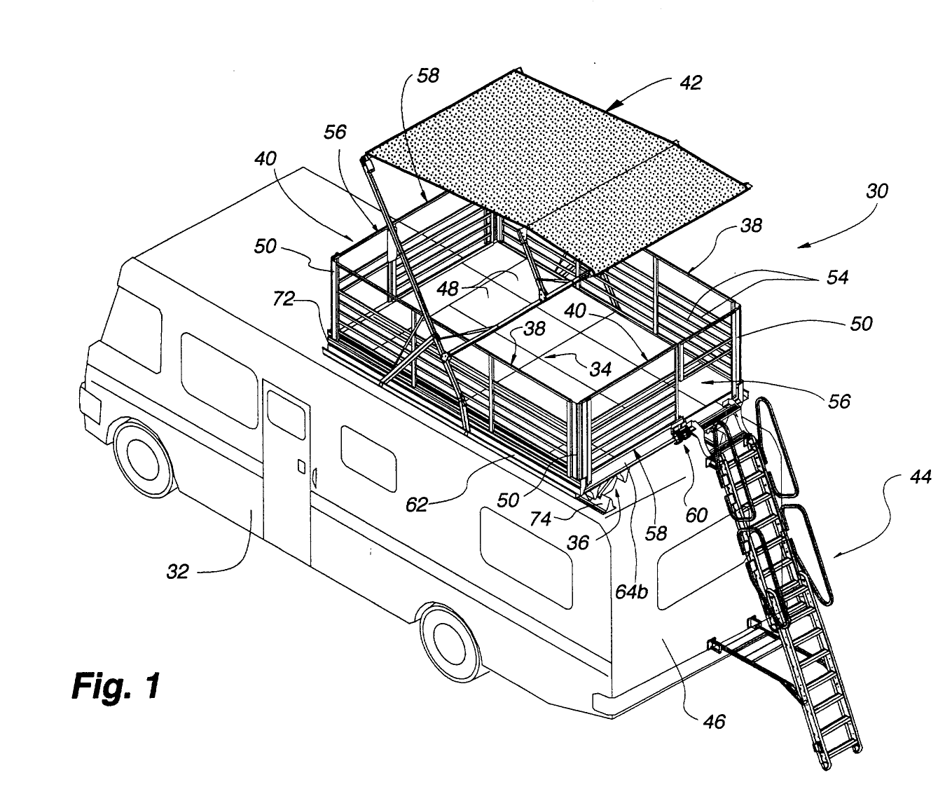

The rooftop desk system 30 of the present invention is shown in FIGS. 1-3 mounted on the top of a recreational vehicle 32. In FIG. 1, the deck system is shown fully extended and can be seen to include a support platform 34 mounted on a base framework 36 with a pair of opposing side rails 38 along opposite sides of the platform, a pair of opposing end rails 40 along opposite ends of the platform, a retractable awning system 42 supported on opposite sides of the platform and a retractable ladder 44 pivotally suspended from the rearward-most end of the platform adjacent to the rear wall 46 of the recreational vehicle.

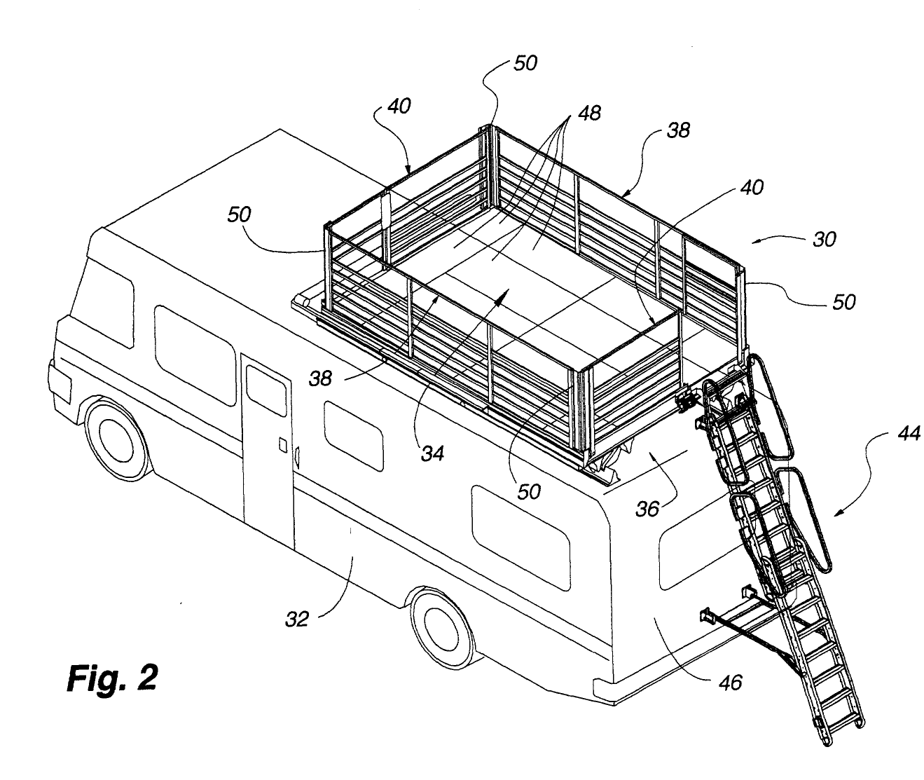

In FIG. 2, the retractable awning 42 for the deck system 30 has been retracted into a folded position adjacent to the top of the recreational vehicle while the remainder of the deck system is shown fully extended.

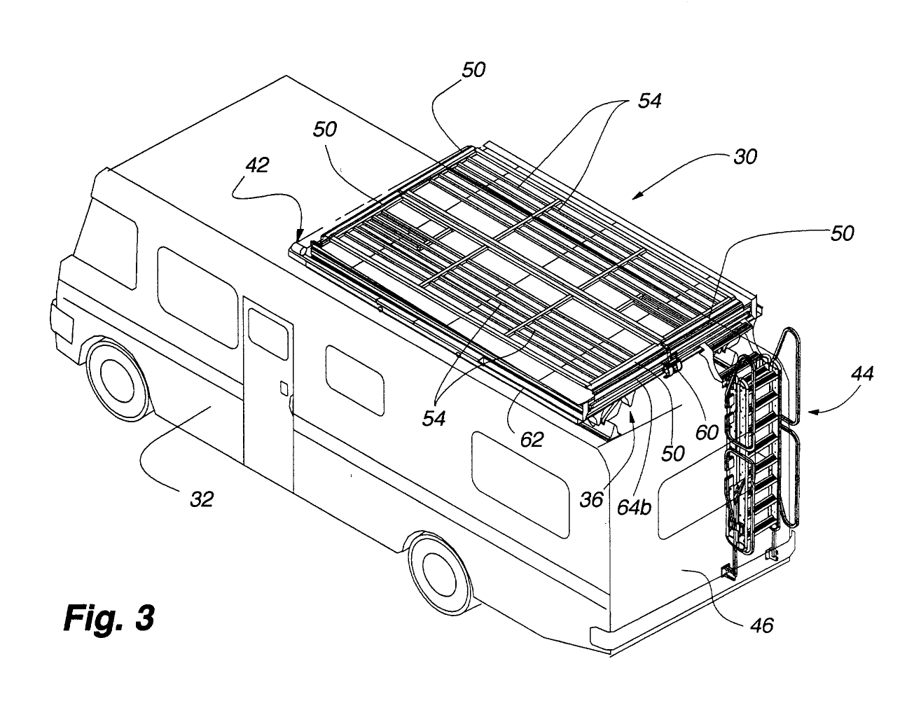

In FIG. 3, the entire deck system 30 is shown in a fully collapsed position with the retractable ladder 44 disposed closely adjacent to the rear wall 46 of the vehicle.

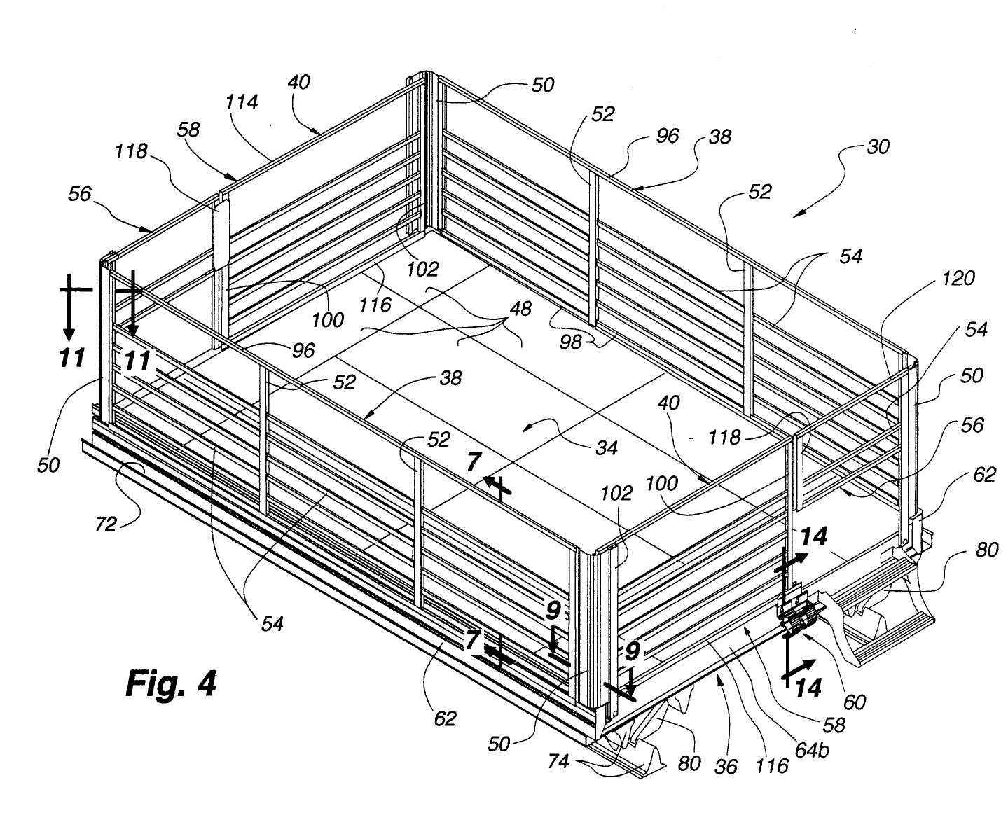

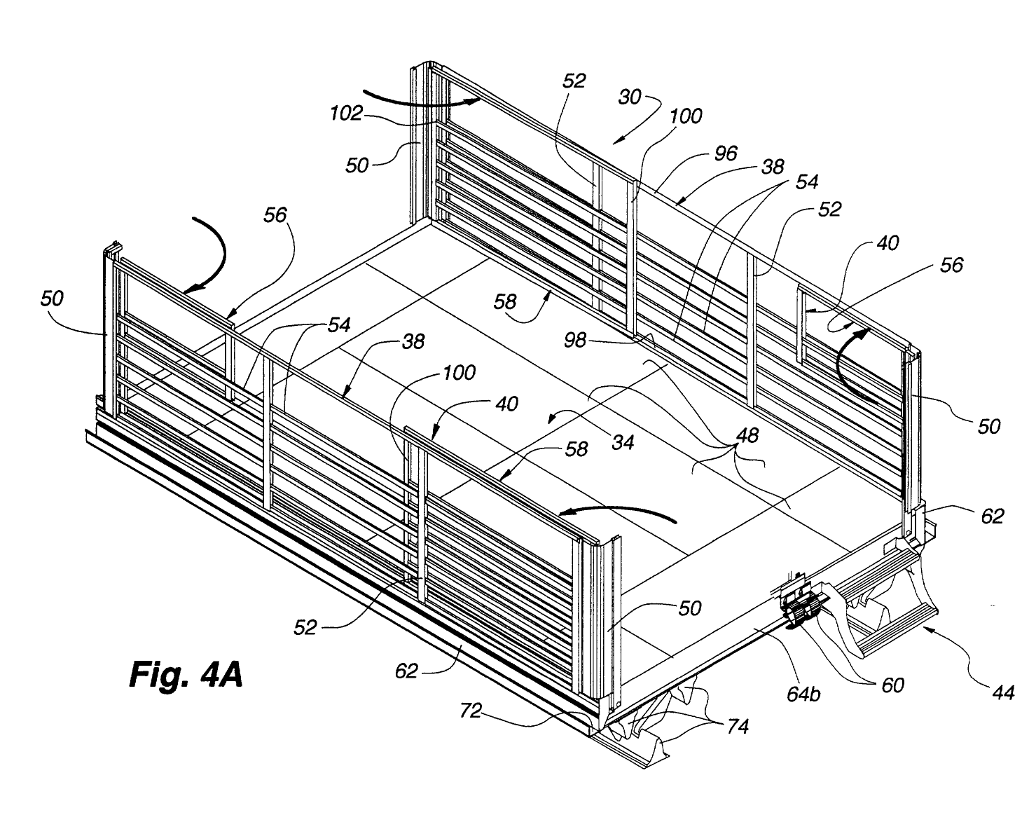

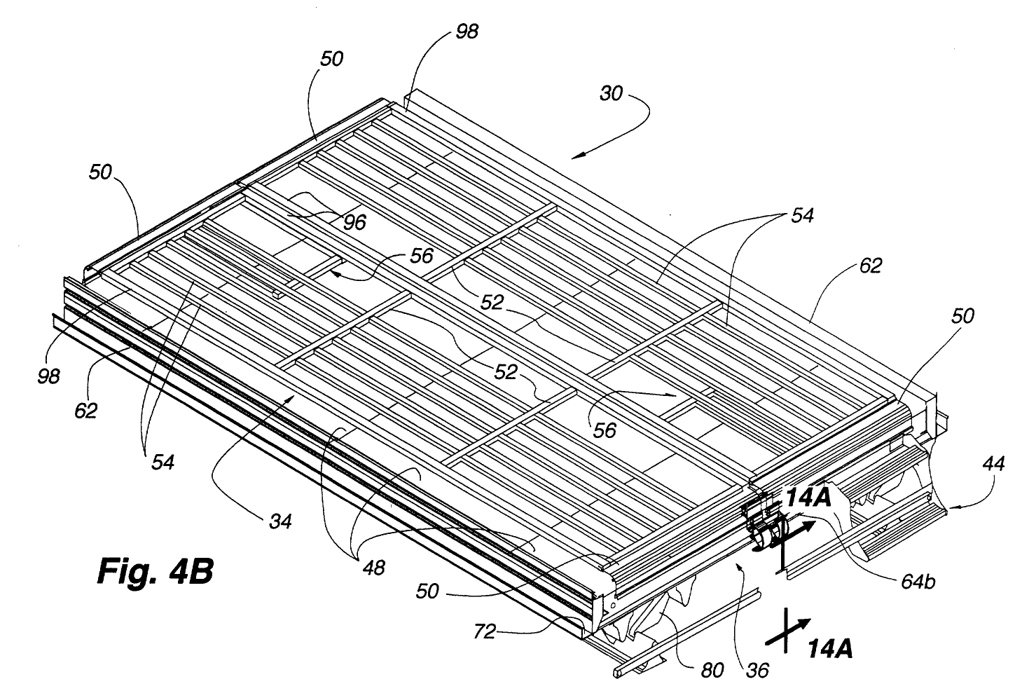

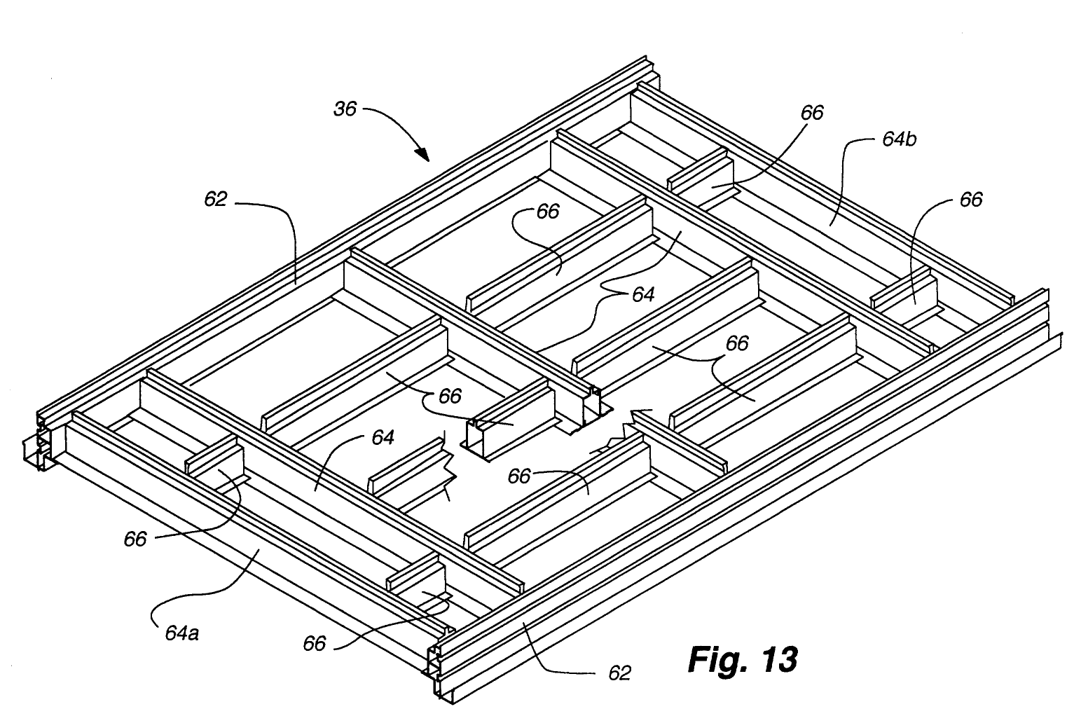

The deck system 30 without the retractable awning 42 is shown in more detail in FIG. 4 and it will there be seen that the support platform 34 is composed of a plurality of planar panels 48 of any suitable material that are supported in adjacent and contiguous side-by-side relationship on the base framework 36, which is shown in FIG. 13 and will be described in more detail later.

The opposed side rails 38 for the system are identical and include end or corner posts 50 forming corners of the system and two intermediate vertical posts 52 which cooperate with the corner posts in supporting a plurality of horizontal, vertically spaced bars 54.

The end rails 40 are also identical having two component parts with one component part forming a pivotal gate 56 allowing access to the platform 34 from the retractable ladder 44 or from the roof of the vehicle at the opposite end of the platform. The pivotal gate 56 is hingedly connected to an adjacent corner post 50. The second or main component 58 of the end rails is pivotally connected to the corner post at the opposite side of the platform from the pivotal gate and it too is hingedly connected to the corner post so that it can be swung into adjacent parallel relationship with the adjacent side rail 38 when folding the deck system into its folded or collapsed condition. The two components of each end rail can be seen positioned in adjacent side-by-side relationship with the associated side rails in FIG. 4a.

As mentioned previously, the gates 56 are pivotally mounted to an adjacent corner post 50 to permit access to and egress from the platform 34 but they also are opened as an initial step in folding the deck system from the fully extended or erect condition of FIG. 4 to the fully folded condition of FIG. 4b. In other words, when it is desired to fold the platform into its storage condition, the components 56 and 58 of each end rail are initially pivoted into adjacent side-by-side relationship with associated side rails and subsequently the side rails are folded downwardly into overlying relationship with the support platform 34 as they are pivotally mounted in a manner to be described later. With the end rails positioned in adjacent side-by-side relationship to the side rails, the side rails can each be folded downwardly into overlying relationship with the platform as shown in FIG. 4b so the entire system is folded into a compact unit, closely adjacent to the top of the recreational vehicle. In fact, in the preferred embodiment the system can be mounted to extend only about 8 inches above the crown of the top of the vehicle. Clamps 60, which will be described in more detail later, mounted at the rear end of the deck system, releasably secure the system in the folded condition of FIG. 4b.

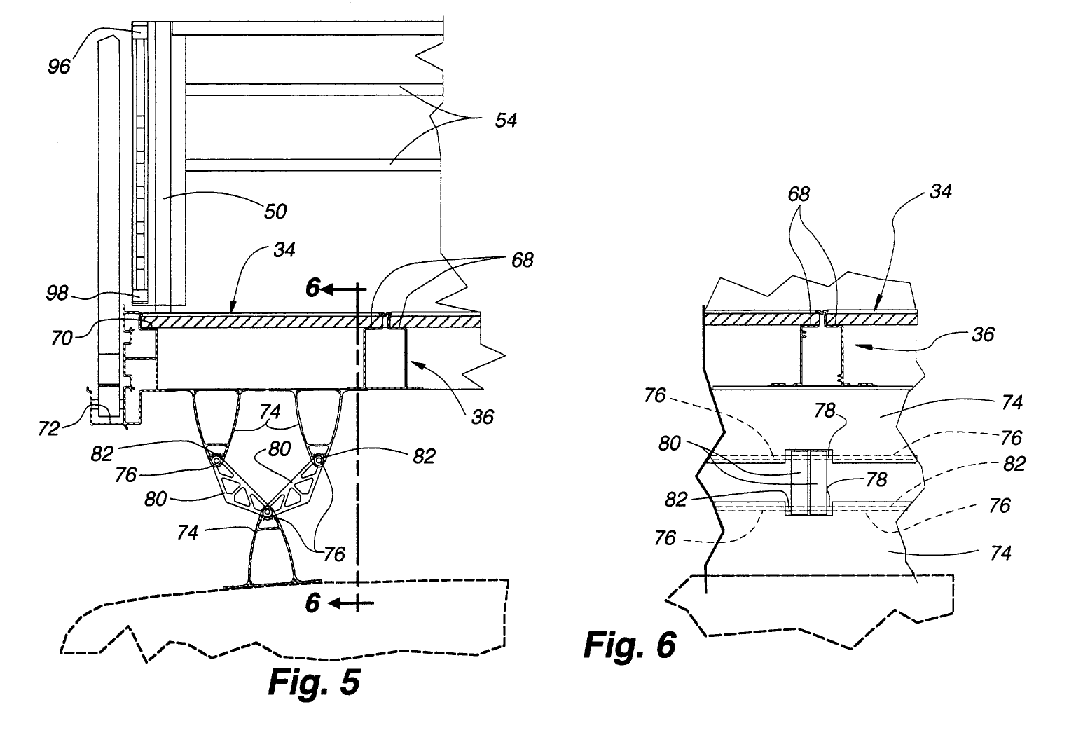

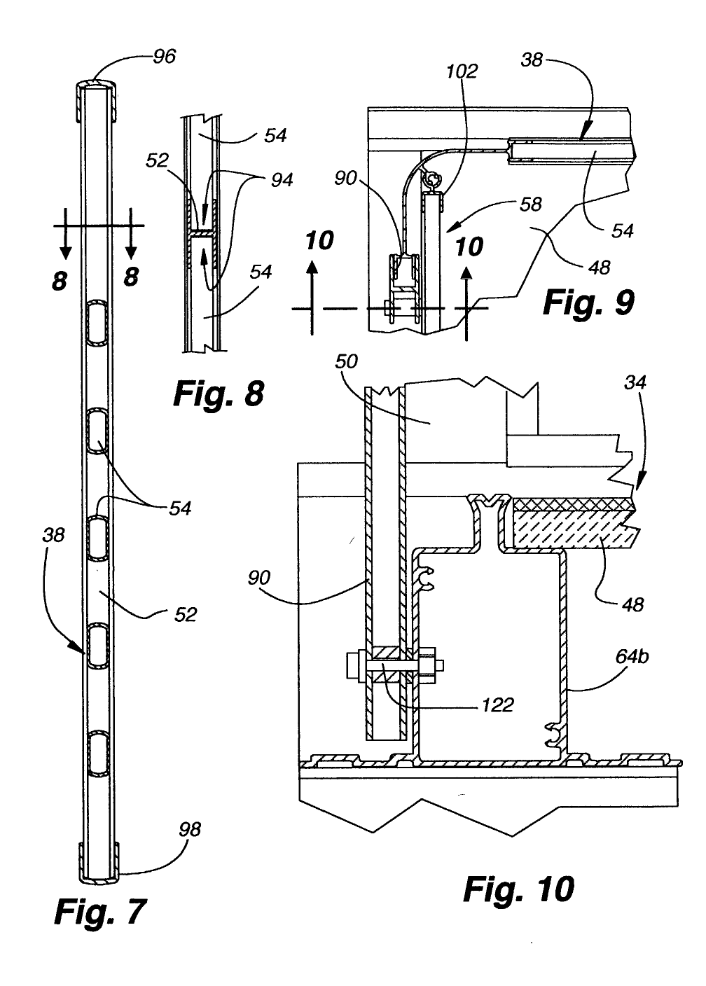

With reference to FIGS. 5, 6, and 13, the base framework 36 for the deck system 30 can be seen to include a pair of side frame members 62 and five cross-frame members 64 perpendicular to the side channels with two of the cross-frame members 64a and 64b constituting end cross-frame members at the front and rear of the deck system. Stringer frame members 66 extend parallel to the side frame members 62 in parallel spaced relationship bridging the gaps between the cross-frame members 64. Each of the frame members is preferably made of a lightweight extruded aluminum material providing desired strength for the framework with minimal weight. The stringers and cross-frame members have their top edges in coplanar relationship so as to cooperate in providing a level surface for supporting the panels 48 of the support platform. Each stringer and cross-frame member has a pair of shoulders 68 extending along its length and adjacent to the top thereof which provide a supporting surface for an edge of a platform panel 48 so the panels can be individually removed if desired.

In FIGS. 5 and 6, the shoulders 68 on the stringers and cross-frame members are illustrated supporting adjacent panels 48 and as seen in FIG. 5, the side frame members 62 also have an inwardly facing shoulder 70 that supports the side edges of the panels positioned adjacent thereto. The side frame members 62 also have an upwardly opening outer channel 72 formed along their lower edges as seen in FIGS. 5 and 13 in which the retractable awning system 42 is mounted as will be described in more detail later.

The base framework 36 is supported in spaced relationship from the top of the recreational vehicle body by sets of elongated support beams 74 that are identical in cross section. Each beam is of triangular cross section as seen in FIG. 5 with a lower beam of each set being secured to the top of the recreational vehicle and extending longitudinally thereof. A pair of upper beams complete the set and are mounted in spaced relationship on the bottom of the base framework so as to extend longitudinally thereof in spaced vertical alignment with the bottom rail. The pair of beams are inverted relative to the lower beam. As best appreciated in FIG. 6, each beam has a longitudinally extending passage 76 along its apex and the passage is interrupted at spaced locations to provide a notch 78 that exposes the passage at that location. A pair of triangularly-shaped brackets 80 are mounted in side-by-side relationship in each notch 78 with one bracket extending from the lower beam to one of the pair of top beams and the other bracket extending from the lower beam to the other of the pair of upper beams. Pivot support pins 82 are extended through the passage in each rail so as to extend along the length thereof and as the pin passes through a notch in the rail, it passes through openings (not seen) in each of the brackets. Accordingly, a pivotal connection is establish between the three beams in the set and the support brackets. By placing a set of such support beams on each side of the top of the vehicle, the platform is securely mounted on the vehicle and in spaced relationship above the roof thereof.

The brackets 80 can be made of any length so the deck system can be elevated any desired amount above the top of the vehicle such as, for example, to accommodate an air conditioning unit, luggage rack, or the like which might already be mounted on the top of the vehicle. On the other hand, if clearance above the top of the vehicle is not important, the brackets can be very short and due to the crown typically found on the top of recreational vehicles and the like, the platform would have a very minimal clearance along the longitudinal centerline of the vehicle while having a greater clearance along the sides where the rails are mounted. In fact, as previously mentioned, by utilizing small brackets so only a minimal clearance is provided along the longitudinal centerline of the vehicle between the deck system and the top of the vehicle, the deck system in its folded condition will extend only about 8 inches above the top of the vehicle along the centerline.

As an alternative to the above, a single lower beam 74 could be utilized with a single vertically aligned upper beam 74 with the beams being directly interconnected with the support pin 82 alleviating the need for brackets. In this arrangement, the notches 78 in the beams would be offset from each other such that the beams could be interdigitated.

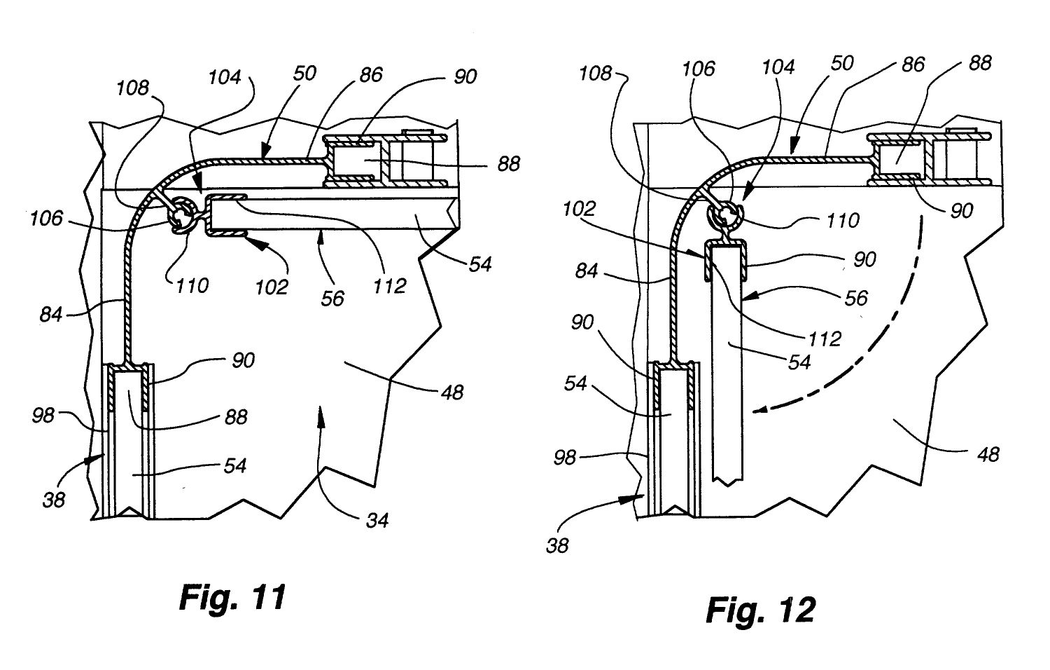

The corner posts 50 for the side rails 38 are probably best shown in FIGS. 11 and 12 and comprise a vertically extending arcuate channel having perpendicularly oriented legs 84 and 86. Each leg has a U-shaped open groove 88 formed on an end cap 90 thereof. One leg 84 of each corner post extends along the adjacent side of the support platform while the other leg 86 extends along the adjacent end of the support platform. The leg 84 extending along the side of the support platform is adapted to receive ends of a first set of the vertically spaced horizontal bars 54. The opposite ends of the bars 54 in the first set are received in one side of the adjacent intermediate vertical post 52. The intermediate vertical posts 52 are of H-shaped cross section as seen in FIG. 8 so as to define oppositely directed channels 94 for receipt of the ends of the bars 54. As will be appreciated, there are illustrated five rows of vertically spaced bars 52 in three sets of bars on each side rail 38. The first set of bars, as mentioned previously, extends between a corner post 50 and the adjacent intermediate post 52, a second set between intermediate posts 52 and a third set between the opposite corner post 50 and the adjacent intermediate post 52. In addition to the bars, each side rail has an upper and lower rail cap 96 and 98, respectively, that extend the full length of the side rail so as to overlie and underlie, respectively, the ends of the intermediate posts and the ends of the end caps 90 of the associated corner posts.

The end rails 40 are formed in a similar manner with five vertically spaced bars 52 of a first set extending horizontally between a free vertical post 100 and a fixed vertical post 102 of the main component 58 of the end rails. The swinging gate components 56 of each end rail 40 are pivotally connected with a fixed post 102 to a corner post 50. A vertical swing post 118 is provided at the opposite end of the gate which is approximately half the height of a corner post so as to extend downwardly from an upper rail cap 120 of the gate a short distance while supporting a pair of lower horizontal bars 54. The fixed vertical post 102 of both the swing gate and the main component is hingedly connected to the adjacent corner post 50. The hinged connection is a tongue-in-groove connection 104, as best seen in FIGS. 11 and 12, with the tongue being formed by a vertically extending bead 106 of C-shaped cross section supported in spaced relationship from the corner post by a bracket 108. The groove 110 of the connection 104 is defined on the vertically extending fixed post with the groove also being of C-shaped cross section that is larger than that of the tongue and adapted to pivotally receive the tongue therein in a conventional manner. The fixed vertical post 102 further has an open channel 112 extending vertically for receiving the ends of the horizontal bars 52 as described previously. Upper and lower rail caps 114 and 116, respectively, are also provided to overlie and underlie the ends of the fixed and free vertical posts of the main component. The free post 100 of the main component is releasably connectable to one of the clamps 60 to secure the main component 58 of the end rail in position as will be described later.

As mentioned previously the side rails 38 are pivotally connected to the base framework 36 and as can be seen in FIG. 10, the pivotal connection is to an end cross-frame member 64b of the base framework. A pivot pin 122 is secured to the cross-frame member 64b and to an end cap 90 in the adjacent corner post 50 so the corner post pivots about the pivot pin allowing the side rail to swing from the fully erected vertical position of FIG. 1 to the horizontal folded position of FIG. 3. Of course, the pivotal connection is provided at each end of each side rail so the side rails can be collapsed into overlying adjacent relationship with the support platform 34 when desired.

FIG. 11 illustrates the relationship of the side and end rails to a corner post 50 with the swinging gate component 56 of an end rail 40 in its normal relationship extending along the end of the platform 34 and in perpendicular relationship with the side rails 38. FIG. 12 shows the swinging gate 56 pivoted about the tongue-in-groove connection 104 into adjacent side-by-side relationship with the associated side rail.

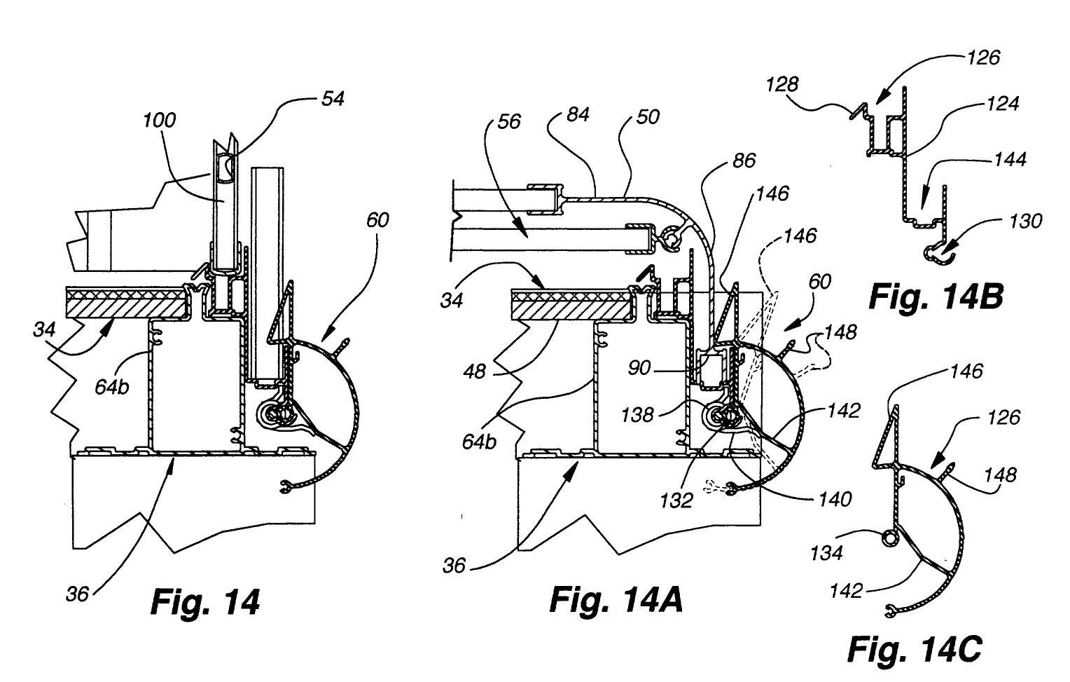

The side and end rails are retained in the folded or collapsed position of FIG. 3 by a pair of the identical clamp members 60 mounted on the cross-frame member 64b of the base framework at the rear end of the deck system and may also be similarly mounted at the front end of the deck system on the cross-frame member 64a but such clamps are not shown. As seen in FIG. 14A, the clamp members are mounted in side-by-side relationship so one clamp member is adapted to secure a folded-down side rail 38 from one side of the deck system while the other clamp member is adapted to secure the folded-down side rail from the opposite side of the deck system. The clamps are also adapted, as seen in FIG. 14, to secure the free vertical posts 100 of the main components 58 of the end rails when the end rails are erect at the ends of the platform.

Each clamp 60, as shown in FIGS. 14-14C, has a pair of component parts with a base bracket component 124 shown in FIG. 14B on which is pivotally mounted a latch component 126 shown in FIG. 14C. The base bracket is secured to the rearmost cross-frame member 64b at an intermediate location along its length. The base bracket has an upper channel 126 with a cam 128 along one edge in which the lower end of the free vertical post 100 of the main component of an end rail can be releasably retained as seen in FIG. 14. The cam can be depressed to allow the post 100 to be removed from the channel 126 to swing the end rail component into face-to-face relationship with the adjacent side rail as when the deck system is to be folded.

An open groove 130 is formed in the bracket at its lower edge which pivotally receives the latch component 126 of the clamp with a pivot pin 132 (FIG. 14A). The latch component is seen in FIG. 14C to have a circular channel component 134 adapted to be seated in the open groove 130 of the base bracket so the pin 132 can retain the latch component in a pivotal relationship relative to the base bracket. The open groove 130 further includes a small recess 136 in which a coil spring 138, as seen in FIG. 14A, is mounted with the coil spring having a biasing arm 140 adapted to engage an abutment plate 142 on the latch component so as to bias the latch component in a counterclockwise direction.

The base bracket 124 also includes a second open channel 144 adapted to receive the leg 86 of a corner post, which extends along the end of the support platform. The open channel 144 cooperates with the latch component 126 to releasably secure the leg 86 in the open channel 144 when the deck is collapsed. The upper end of the latch component 126 has a cam element 146 that partially overlies the upwardly opening channel 144 in the base bracket in a neutral position of the components of the clamp but the cam element 146 allows the latch component to pivot in a clockwise direction when engaged by a leg 86.

In operation of the clamp 60, when the side rail members 38 are pivoted downwardly into overlying relationship with the platform 34, and the end rails 40 are in face-to-face relationship therewith, the leg 86 of a corner post 50 is advanced downwardly toward the second upwardly opening channel 144 in the base bracket member. The leg 86 engages the cam element 146 of the latch component forcing the latch component to pivot in a clockwise direction into the dash line position of FIG. 14A. After the leg 86 of the corner post passes the cam element 146 of the latch component, the latch component pivots in a counterclockwise direction under the bias of the coil spring 138 so the cam element overlies the end cap 90 of the leg 86 of the corner post to retain the leg of the corner post within the bracket base thereby clamping the side rail to the base framework to retain the side and end rails in closely adjacent overlying relationship with the platform 34.

In order to release the rails so as to extend or erect the deck system, a finger tab 148 is provided on the latch component 126 so the latch component can be easily pivoted in a clockwise direction causing the cam element 146 to be removed from the path of travel of the leg 86 of the corner post so the corner post can be lifted thereby lifting the side rails 38 and the end rails 40 until the side rails are vertically oriented. After the side rails are vertically oriented as shown in FIG. 2, the end rails can be pivotally moved about the connection 104 into a perpendicular relationship with the side rails so the deck system is in the erected position of FIG. 2 and the free post 100 of the main component 58 of the end rail is releasably secured in the open channel 144 of the associated clamp 60. At that point in time, the awning 42 can be extended if desired or allowed to remain in its folded or retracted position adjacent to the roof of the vehicle.

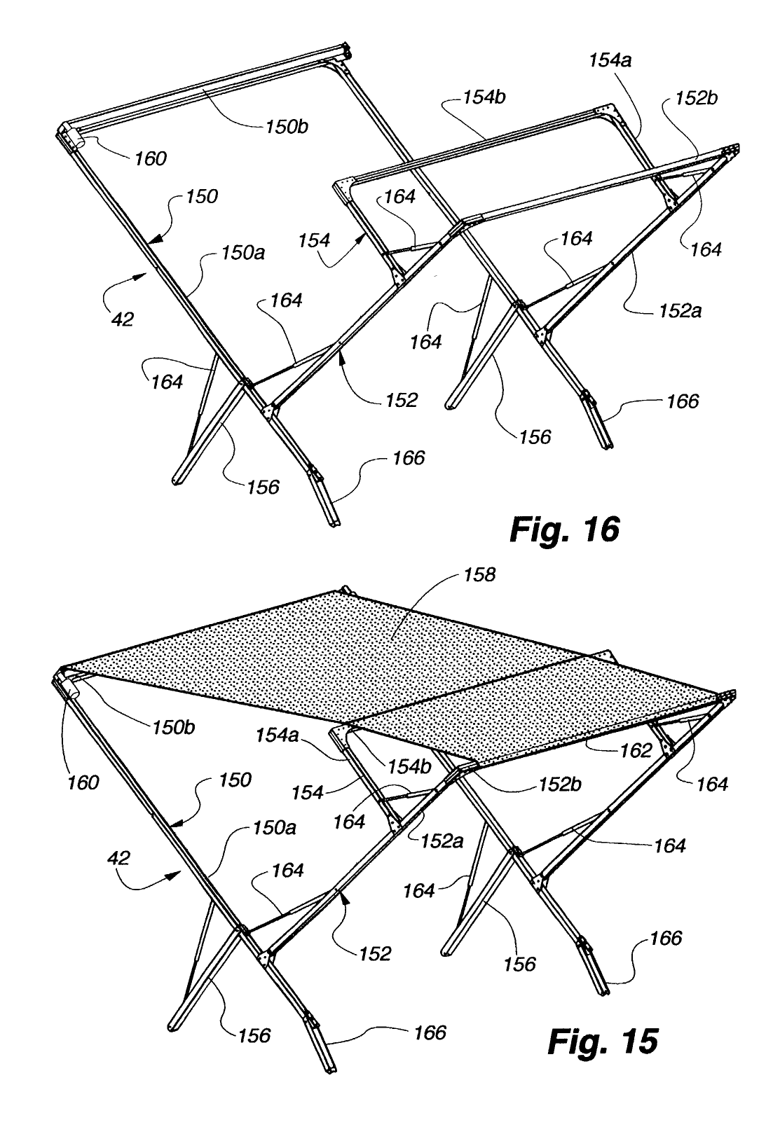

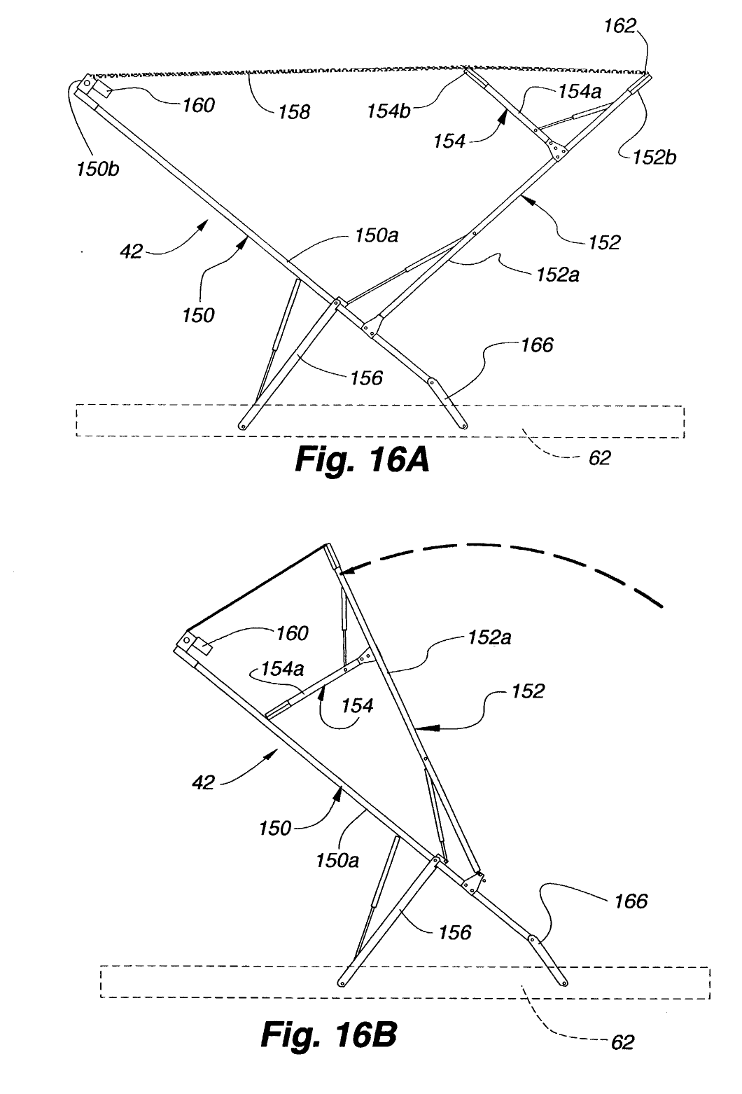

As mentioned previously, the retractable awning system 42 is mounted in the open channel 72 of the side frame members of the base framework. The awning is movable between the extended position of FIG. 1 and the retracted position of FIGS. 2 and 3 so users of the deck system have the option of using the awning or not. The awning itself is illustrated in detail in FIGS. 15-19 and can be seen to include a first primary U-shaped frame member 150, a secondary U-shaped frame member 152 pivotally connected to the primary frame member, an auxiliary U-shaped frame member 154 pivotally connected to the secondary frame member and a pair of support legs 156 also pivotally connected to the primary frame member 150. Each of the U-shaped frame members has a pair of parallel legs 150a, 152a and 154a, respectively, and a cross-frame member 150b, 152b and 154b, respectively, interconnecting the legs at their upper ends.

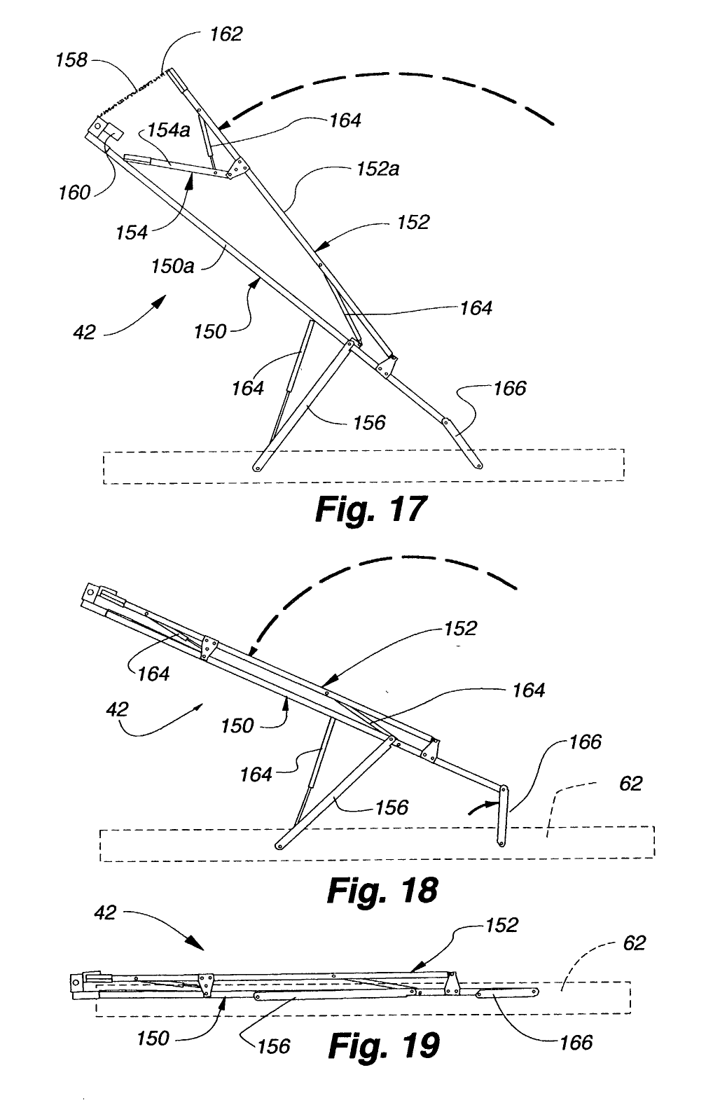

The cross-frame member 150b for the primary U-shaped frame member 150 constitutes a motorized roll-up awning having a retractable canopy or awning sheet 158 with the canopy being biased toward a retracted position about a roll bar (not seen) by biasing means in the awning as is conventional with many retractable awnings. A reversible motor 160 selectively extends or retracts the awning canopy by reversibly rotating the roll bar. The free end 162 of the canopy 158 is secured to the cross-frame member 152b of the secondary U-shaped frame 152 and the cross-frame member 154b of the auxiliary U-shaped frame 154 engagingly supports the canopy at an intermediate location when the awning is extended. A plurality of gas springs 164 are utilized in the awning structure to retain the awning in the extended position but the gas springs can be overridden by the motor 160 that drives the awning when the awning is retracted. In other words, when the awning is retracted, the motor is driven to rotate the roll bar on the primary frame 150, about which the canopy is wrapped, in a predetermined direction while pulling the free edge 162 of the awning sheet, and the secondary U-shaped frame 152 to which it is attached, toward the roll bar on the primary frame. This movement is illustrated in FIG. 17. Further retracting movement of the awning sheet as illustrated in FIG. 18, pulls the secondary frame into parallel relationship with the primary frame. The awning can then be fully moved into its folded or retracted position by manually pushing the roll bar downwardly into the position of FIG. 19.

As can be appreciated, the parallel legs 150a of the primary frame 150 have extension links 166 at the free ends thereof with the extension links being pivotally mounted within the open channel 72 of the side frame members 62 of the base framework 36. Similarly, the associated ends of the parallel legs 156 are also pivotally mounted in the channel 72 and the dimensions of the legs, links, and the channel allow the legs and links to be received in the channel when the awning is fully retracted as shown in FIG. 19 with the roll-up awning and the cross-frame members 152a and 154a of the secondary and auxiliary frames extending beyond the platform 34 of the deck system 30 so as to be positioned immediately adjacent to the top of the recreational vehicle. Of course, to extend the awning, one merely lifts the roll-up awning to the position shown in FIG. 18 and energizes the motor 160 on the roll bar in a direction to allow the awning sheet to unwind from the roll bar and as it unwinds, the gas springs 164 separate the frame members until the frame members assume the position of FIG. 15 with the awning canopy 158 fully extended in a horizontal plane across a portion of the platform 34 of the deck system.

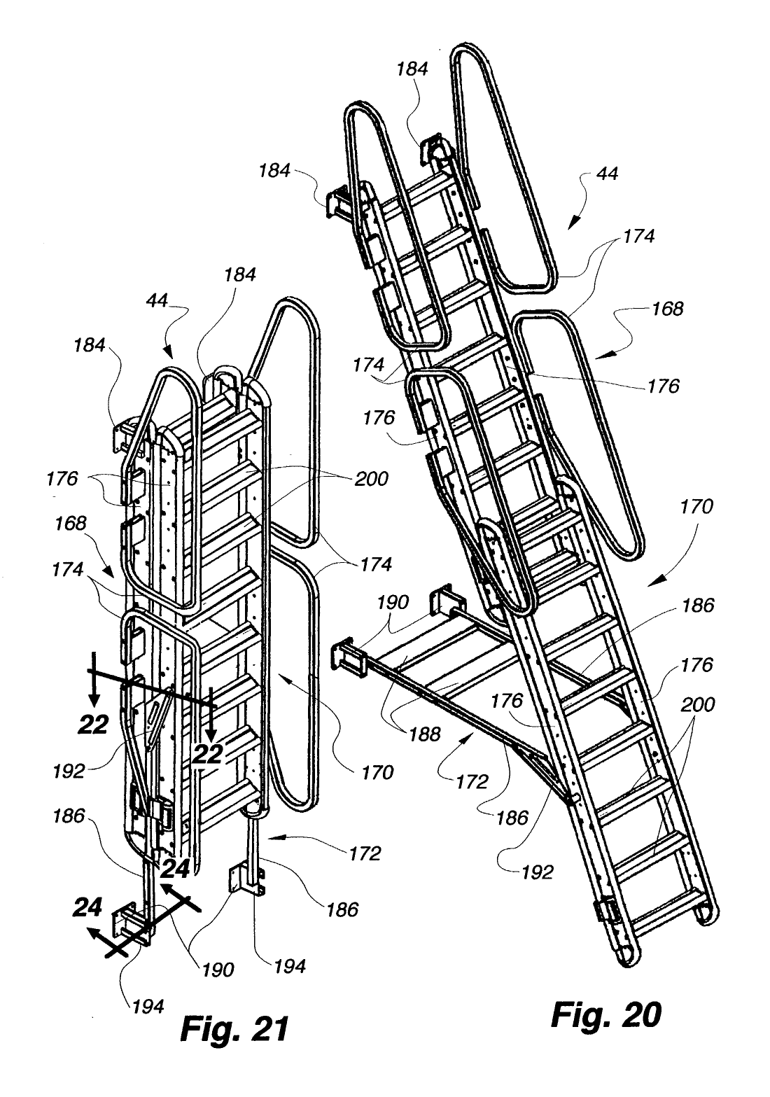

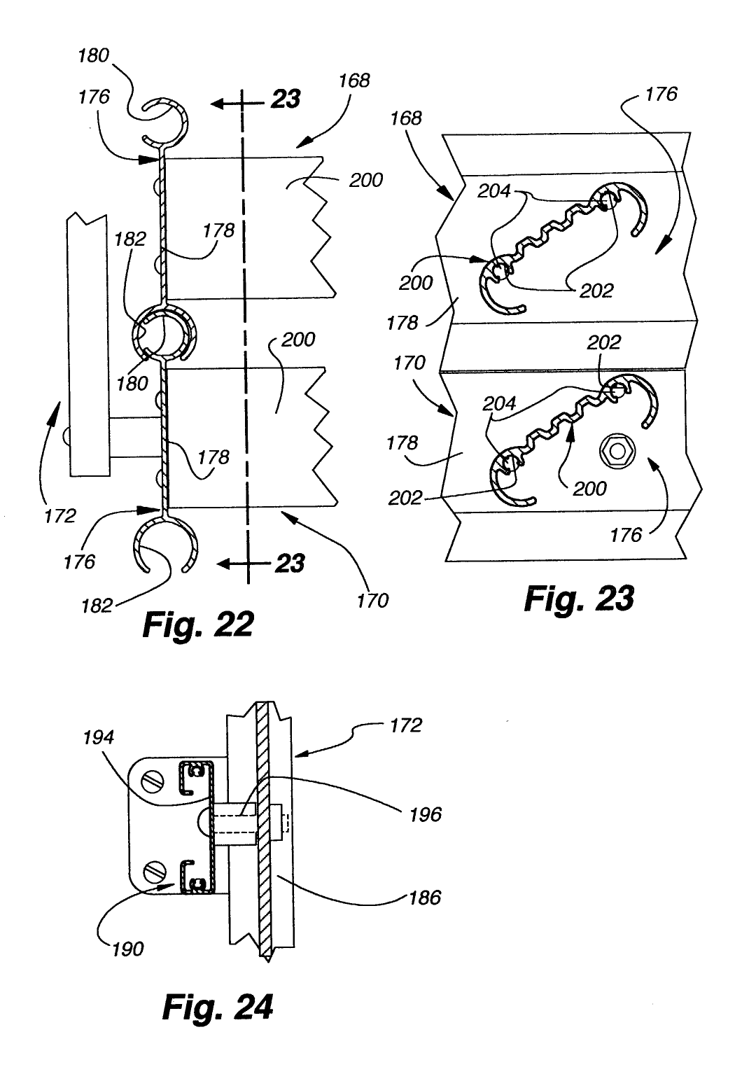

The retractable ladder 44 that permits access to the deck system from ground level is shown in FIGS. 20-24. The ladder generally includes upper and lower slidably related ladder components 168 and 170, respectively, and a pivotal brace system 172 for changing the angular orientation of the ladder as it is moved between extended and retracted positions. The upper ladder component 168 has two pairs of hand rails 174 to stabilize a user as he or she climbs the ladder. As best seen in FIG. 22, each of the upper and lower ladder components has identical side bars 176 with each side bar having a flat base portion 178 with a longitudinally extending C-shaped small groove 180 along one longitudinal edge opening laterally and a larger C-shaped groove 182 along the opposite edge opening in a direction parallel to the base or portion 178. The large groove 182 of the upper ladder component 168 is adapted to slidably receive the small groove 180 of the lower ladder component 170 so the upper and lower components are slidably related to each other. The upper end of the upper ladder component is pivotally mounted to the base framework 36 of the deck system 30 with a pair of brackets 184 (FIGS. 20 and 21) even though the brackets could also be mounted on the rear wall of the vehicle at an adjacent location.

The lower ladder component 170 is connected to the pivotal brace system 172 at an intermediate location along the length of the lower ladder component. The brace system has a pair of side arms 186 interconnected by a pair of spacers 188 and wherein the side arms are pivotally anchored at an inner end to a pair of brackets 190 secured to the end wall 46 of the recreational vehicle at a relatively low location. The opposite ends of the side arms are connected to brackets 192 which are pivotally connected to the side bars 176 of the lower ladder component so that as the lower ladder component is slid downwardly relative to the upper ladder component in extending the ladder, the brace system pivots away from the rear wall of the vehicle until the side arms are substantially horizontal and the lower ladder component rests on the ground behind the vehicle as seen in FIG. 1.

It will be appreciated that in the retracted position of the ladder as illustrated in FIG. 21, the upper and lower ladder components 168 and 170, respectively, are immediately adjacent to each other in face-to-face relationship and in a vertical orientation. As the lower component 170 is slid downwardly relative to the upper component, the brace system 172 forces the lower component away from the vehicle body until the ladder is desirably inclined as shown in FIG. 21. The connection of the side arms 186 to the brackets 190 is illustrated in detail in FIG. 24 and it will be appreciated that each bracket 190 has a channel-shaped member 194 that receives one end of a pivot pin 196 with the opposite end of the pivot pin extending through a brace arm 186 so the brace arm can pivot relative to the bracket.

Each step 200 of the ladder is an extruded member of a cross section shown in FIG. 23 and has a pair of spaced channels 202 adapted to receive mounting pins 204 that are provided at spaced locations along the length of each side bar 176 of the ladder. The pins, of course, support the steps at desired locations along the length of the ladder.

Although the present invention has been described with a certain degree of particularity, it is understood that the present disclosure has been made by way of example, and changes in detail or structure may be made without departing from the spirit of the invention as defined in the appended claims.

What is claimed is:

1. A rooftop deck system for vehicles comprising in combination:
a base framework adapted for attachment to the roof of a vehicle,
a platform supported by said base framework,
rails mounted on said base framework in substantially surrounding relationship with said platform for movement between an erect position extending upwardly relative to said platform and a collapsed position.

2. The system of claim 1 wherein said rails are hingedly mounted on said base framework and overlie said platform in substantially parallel relationship therewith when in the collapsed position.

3. The system of claim 1 further including an awning operatively connected to said base framework and movable between extended and retracted positions.

4. The system of claim 3 wherein said awning is also movable between an erect position and a collapsed position.

5. The system of claim 4 wherein said rails and awning are simultaneously movable between the erect and collapsed positions.

6. The system of claim 3 wherein said awning includes an awning canopy and a roll bar about which the awning sheet is rolled in the retracted position.

7. The system of claim 6 wherein said awning canopy has a free edge that is movable toward and away from said roll bar to move the awning between the retracted and extended positions.

8. The system of claim 7 wherein said awning includes a primary frame supporting opposite ends of said roll bar and a secondary frame secured to said free edge of the awning canopy.

9. The system of claim 8 wherein said secondary frame is pivotally connected to said primary frame.

10. The system of claim 9 wherein said awning further includes an intermediate frame positioned between said roll bar and said free edge for supporting said awning canopy in the extended position of the awning and wherein said intermediate frame is pivotally connected to said secondary frame.

11. The combination of the system of claim 1 or 3 and a vehicle further including a collapsible ladder adapted to be operatively connected to said vehicle whereby users of the system can access said platform by climbing the ladder.

12. The combination of claim 11 wherein said ladder is longitudinally extendable and includes a movable brace engaged with said vehicle to change the inclination of the ladder.

13. The combination of claim 12 wherein said ladder includes two slidably related frame components with spaced step bars thereon, said frame components being positionable in overlapping relationship or in substantially longitudinally aligned relationship.

14. The combination of claim 13 wherein said brace is pivotally connected to one of said frame components.
